(19) United States
(12) Patent Application Publication
(10) Pub. No.: US 2011/0193344 A1
(43) Pub. Date: Aug. 11, 2011

(54) Control Network for Wind Turbine Park

(75) Inventors: Wallace Lafferty, Katy, TX (US); Chakradhar Byreddy, Spring, TX (US)

(73) Assignee: VESTAS WIND SYSTEMS A/S, Randers SV (DK)

(21) Appl. No.: 12/980,704

(22) Filed: Dec. 29, 2010

(51) Int. Cl. H02P 9/04

(52) U.S. Cl. 290/44

(57) ABSTRACT

A wind park comprising a plurality of wind turbines that are coupled to each other via a control network. Control data, for example, data derived from sensors may be exchanged between the wind turbines via the control network, thereby allowing the wind turbines of the wind park to adjust operational parameters based on data received from other wind turbines of the wind park.

### FIELD OF THE INVENTION

Embodiments of the invention are generally related to wind turbine parks, and more specifically to a control network that connects a plurality of wind turbines in a wind turbine park.

### BACKGROUND

In recent years, there has been an increased focus on reducing emissions of greenhouse gases generated by burning fossil fuels. One solution for reducing greenhouse gas emissions is developing renewable sources of energy. Particularly, energy derived from the wind has proven to be an environmentally safe and reliable source of energy, which can reduce dependence on fossil fuels.

Energy in wind can be captured by a wind turbine, which is a rotating machine that converts the kinetic energy of the wind into mechanical energy, and the mechanical energy subsequently into electrical power. Common horizontal-axis wind turbines include a tower, a nacelle located at the apex of the tower, and a rotor that is supported in the nacelle by means of a shaft. The shaft couples the rotor either directly or indirectly with a rotor assembly of a generator housed inside the nacelle.

A wind park is a collection of wind turbines that are connected to the power grid and collectively supply electrical power to the power grid. The power grid has defined parameters, in particular, a defined voltage and a defined frequency. Power grid parameters are defined in a technical specification called the grid code. The grid code also defines the required behavior of generating units such as wind turbines during grid faults, e.g., during severe dips in the grid voltage.

### SUMMARY OF THE INVENTION

Embodiments of the invention are generally related to wind turbine parks, and more specifically to a control network that connects a plurality of wind turbines in a wind turbine park.

One embodiment of the invention provides a method for operating a wind park. The method generally comprises determining, at a first wind turbine in the wind park, a condition that will affect at least a second wind turbine of the wind park, and transferring data regarding the condition to the second wind turbine via a control network coupling the first wind turbine to at least the second wind turbine. The method further comprises adjusting, at the second wind turbine, at least one operational parameter of the wind turbine in response to receiving the data regarding the condition from the first wind turbine.

Another embodiment of the invention provides computer readable storage medium comprising a program product which, when executed by a processor, is configured to perform an operation. The operation generally comprises determining, at a first wind turbine in the wind park, a condition that will affect at least a second wind turbine of the wind park, and transferring data regarding the condition to the second wind turbine via a control network coupling the first wind turbine to at least the second wind turbine. The method further comprises adjusting, at the second wind turbine, at least one operational parameter of the wind turbine in response to receiving the data regarding the condition from the first wind turbine.

Yet another embodiment of the invention provides a wind park comprising a plurality of wind turbines, each wind turbine comprising a networked computer, wherein at least a first networked computer in a first wind turbine is coupled with at least one second networked computer in a second turbine via a control network. In general, the first networked computer and the second networked computer each comprise a memory comprising a control program, and a processor which, when executing the control program is configured to perform operations for exchanging control data between the first networked computer and the second networked computer.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary wind turbine according to an embodiment of the invention.

FIG. 2 illustrates an exemplary nacelle according to an embodiment of the invention

FIG. 3 illustrates an exemplary wind power plant according to an embodiment of the invention.

FIG. 4 illustrates an exemplary network computer according to an embodiment of the invention.

FIG. 5 illustrates a wind park according to an embodiment of the invention.

FIG. 6 is a flow diagram of exemplary operations performed by wind turbines of a wind park according to an embodiment of the invention.

FIG. 7 is another flow diagram of exemplary operations performed by wind turbines of a wind park according to an embodiment of the invention.

### DETAILED DESCRIPTION

Embodiments of the invention are related to a wind park comprising a plurality of wind turbines that are coupled to each other via a control network. Control data, for example, data derived from sensors may be exchanged between the wind turbines via the control network, thereby allowing the wind turbines of the wind park to adjust operational parameters based on data received from other wind turbines of the wind park.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

The following is a detailed description of embodiments of the invention depicted in the accompanying drawings. The embodiments are examples and are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

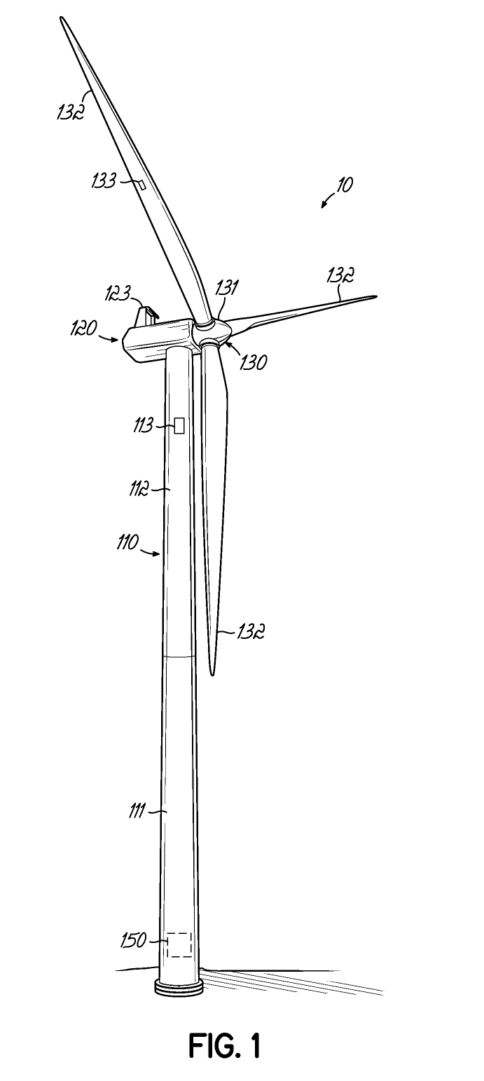

FIG. 1 illustrates an exemplary wind turbine 100 according to an embodiment of the invention. As illustrated in FIG. 1, the wind turbine 100 may include a tower 110, a nacelle 120, and a rotor 130. In one embodiment of the invention the wind turbine 100 may be an on shore wind turbine. However, embodiments of the invention are not limited only to on shore wind turbines. In alternative embodiments, the wind turbine 100 may be an off shore wind turbine located over a water body such as, for example, a lake, an ocean, or the like.

The tower 110 of wind turbine 100 may be configured to raise the nacelle 120 and the rotor 130 to a height where strong, less turbulent, and generally unobstructed flow of air may be received by the rotor 130. The height of the tower 110 may be any reasonable height. The tower 110 may be made from any reasonable material, for example, steel, concrete, or the like. In some embodiments the tower 110 may be made from a monolithic material. However, in alternative embodiments, the tower 110 may include a plurality of sections, for example, two or more tubular steel sections 111 and 112, as illustrated in FIG. 1. In some embodiments of the invention, the tower 110 may be a lattice tower. Accordingly, the tower 110 may include welded steel profiles.

The rotor 130 may include a rotor hub (hereinafter referred to simply as the “hub”) 131 and at least one blade 132 (three such blades 132 are shown in FIG. 1). The rotor hub 131 may be configured to couple the at least one blade 132 to a shaft (not shown). In one embodiment, the blades 132 may have an aerodynamic profile such that, at predefined wind speeds, the blades 132 experience lift, thereby causing the blades to radially rotate around the hub. The movement of the blades may also cause the shaft of the wind turbine 100 to rotate. The nacelle 120 may include one or more components configured to convert aero-mechanical energy of the blades to rotational energy of the shaft, and the rotational energy of the shaft into electrical energy.

The wind turbine 100 may include a plurality of sensors for monitoring a plurality of parameters associated with, for example, environmental conditions, wind turbine loads, performance metrics, and the like. For example, a strain gauge 133 is shown on the blade 132. In one embodiment, the strain gauge 133 may be configured to detect bending and or twisting of the blades 132. The information regarding bending and twisting of the blades may be necessary to perform one or more operations that reduce the loads on the blades 132 that may occur, for example, during high wind gusts. In such situations, the blades may be pitched to reduce the loads, thereby preventing damage to the blades.

FIG. 1 also illustrates an accelerometer 113 that may be placed on the tower 110. The accelerometer 113 may be configured to detect horizontal movements and bending of the tower 110 that may be caused due to the loads on the wind turbine 100. The data captured by the accelerometer 113 may be used to perform one or more operations for reducing loads on the wind turbine 100. In some embodiments of the invention, the accelerometer 113 may be placed on the nacelle 120.

FIG. 1 also depicts a wind sensor 123. Wind sensor 123 may be configured to detect a direction of the wind at or near the wind turbine 100. By detecting the direction of the wind, the wind sensor 123 may provide useful data that may determine operations to yaw the wind turbine 100 into the wind. The wind sensor 123 may also detect a speed of the wind. Wind speed data may be used to determine an appropriate pitch angle that allows the blades 132 to capture a desired amount of energy from the wind. In some embodiments, the wind sensor 123 may be integrated with a temperature sensor, pressure sensor, and the like, which may provide additional data regarding the environment surrounding the wind turbine. Such data may be used to determine one or more operational parameters of the wind turbine to facilitate capturing of a desired amount of energy by the wind turbine 100.

While a strain gauge 133, accelerometer 113, and wind sensor 123 are described herein, embodiments of the invention are not limited to the aforementioned types of sensors. In general, any type and number of sensors may be placed at various locations of the wind turbine 100 to facilitate capturing data regarding structural health, performance, damage prevention, acoustics, and the like.

FIG. 1 further illustrates a networked computer 150 located inside the wind turbine 100. The networked computer 150 may be located at any location in the wind turbine 100, for example, at the base of the tower 110, in the nacelle 120, and the like. The networked computer 150 is described in greater detail below.

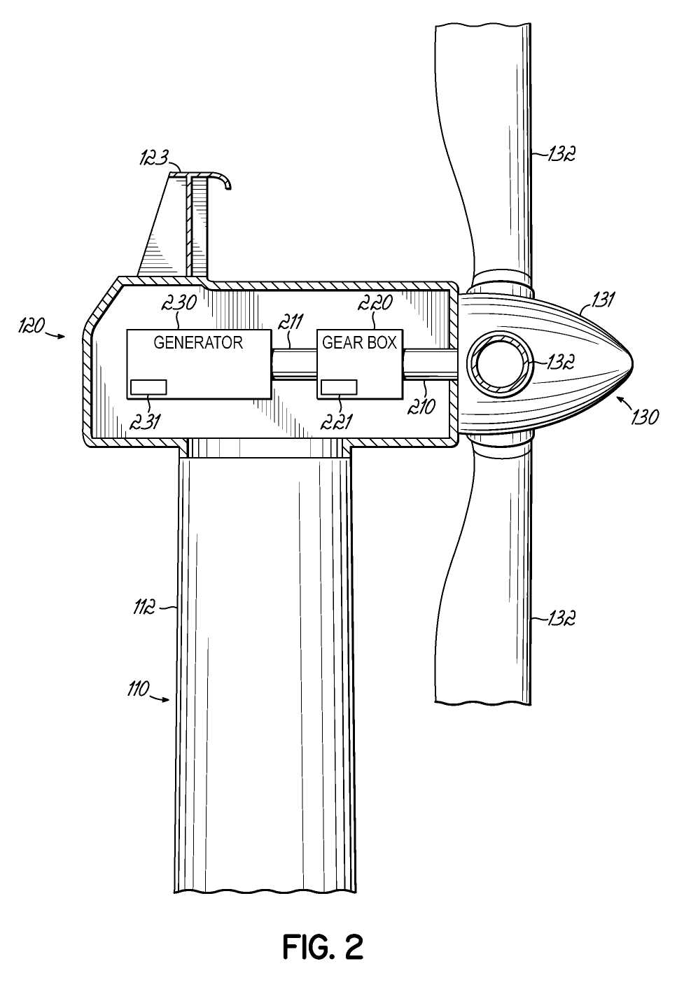

FIG. 2 illustrates a more detailed view of a nacelle 120 according to an embodiment of the invention. As illustrated in FIG. 2, the nacelle 120 may include at least a low speed shaft 210, a high speed shaft 211, a gearbox 220, and a generator 230, according to one embodiment. In one embodiment, the low speed shaft 210 may couple the gearbox 230 to the hub 130, as illustrated in FIG. 2. The gearbox 230 may rely on gear ratios in a drive train to provide speed and torque conversions from the rotation of the low speed shaft 210 to the rotor assembly of the generator 230 via the high speed shaft 211.

In an alternative embodiment, the low speed shaft 210 may directly connect the hub 130 with a rotor assembly of the generator 230 so that rotation of the hub 130 directly drives the rotor assembly to spin relative to a stator assembly of the generator 230. In embodiments where the low speed shaft 210 is directly coupled to the hub 130, the gear box 220 may not be included.

The generator 230 may be configured to generate a three phase alternating current based on one or more grid requirements. In one embodiment, the generator 230 may be a synchronous generator. Synchronous generators may be configured to operate at a constant speed, and may be directly connected to the grid. In some embodiments, the generator 230 may be a permanent magnet generator. In alternative embodiments, the generator 230 may be an asynchronous generator, also sometimes known as an induction generator. Induction generators may or may not be directly connected to the grid. For example, in some embodiments, the generator 230 may be coupled to the grid via one or more electrical devices configured to, for example, adjust current, voltage, and other electrical parameters to conform with one or more grid requirements. Exemplary electrical devices include, for example, inverters, converters, resistors, switches, and the like.

Embodiments of the invention are not limited to any particular type of generator or arrangement of the generator and one or more electrical devices associated with the generator in relation to the electrical grid. Any suitable type of generator including (but not limited to) induction generators, permanent magnet generators, synchronous generators, or the like, configured to generate electricity according to grid requirements falls within the purview of the invention.

In some embodiments, a plurality of sensors may be included in the nacelle 120 to monitor the structural health of the components therein, the quality of the power generated, and the like. For example, a sensor 221 may be placed in the gear box 220 to detect mechanical strain and wear/tear of the gear box 220. A sensor 231 may be placed in the generator 230 to detect the quality of the power signal generated by the generator 230.

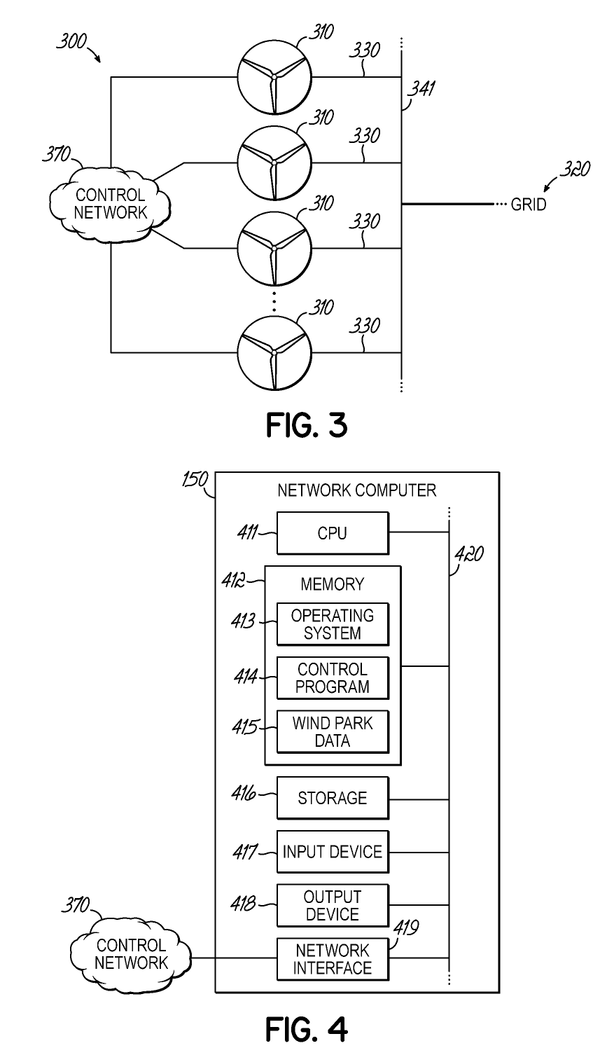

FIG. 3 illustrates an exemplary power plant system 300 according to an embodiment of the invention. As illustrated in FIG. 3, the power plant system 300 may include at least one wind turbine generator 310 (four such wind turbine generators 310 are shown) coupled with a grid 320 via transmission lines 330. In one embodiment, each of the transmission lines 330 may include a set of three lines for transferring a three phase alternating current according to one or more requirements of the grid 320. For example, the wind turbine generators 310 may be configured to provide power at a controlled frequency and voltage to the grid. As illustrated in FIG. 3, the transmission lines 330 from the wind turbine generators 310 may be coupled with the grid at a point of common coupling (PCC) 341. While not shown in FIG. 3, in some embodiments, PCC 341 may include one or more electrical devices, for example, transformers, switches, and the like.

The power supplied by the wind turbine generators 310 to the grid 320 may include both active power and reactive power. In general, active power, or real power, refers to the power that is transferred from the wind turbine generators to the grid. Reactive power refers to the power that cycles back and forth between the wind turbine generators 310 and the grid 320. Maintaining control over reactive power in the system may be necessary for several reasons. For example, reactive power control may be necessary for controlling the voltage at predefined locations, e.g., the PCC 341. Reactive power control may also be necessary for maintaining proper magnetization of components within the wind turbine generators 310.

In general, grid codes define minimum requirements for active power, reactive power, voltages and current frequencies, and the like for operating wind turbines. Furthermore, the grid codes may define required performance for the wind turbine generators 310 during grid faults. Grid faults generally involve an undesirable change in magnitude of the grid voltage or grid frequency. For example, a short circuit in the grid may cause the grid voltage to drop significantly. Such drastic changes in grid voltage may damage components of the wind turbine resulting in expensive repairs and/or replacements.

As illustrated in FIG. 3, the wind turbines 310 may be coupled to a control network 370. In general, the control network 370 may be a local area network connecting the wind turbines 310 in a wind park. In one embodiment, the control network 370 may be a wired network comprising, for example, Ethernet and/or twisted pair cabling. In an alternative embodiment, the control network 370 may be a wireless network based on, for example, the IEEE 802.11 standards. However, other wireless communication protocols may also be implemented in other embodiments. In some embodiments, the control network 370 may include a combination of one or more interconnected wireless and/or wired networks.

In one embodiment of the invention, the network 370 may be a broadcast network. Accordingly, data may be sent from one turbine to every other turbine in the wind park. In an alternative embodiment, data may be sent from one turbine to only selected few turbines. In one embodiment, each turbine of a wind park may be directly connected to every other turbine in the wind park. Alternatively, each turbine may be connected to one or more adjacent turbines. In such networks, transferring data from one turbine to another turbine may involve transferring the data through one or more intermediate turbines.

In one embodiment of the invention, a network computer 150 (see FIG. 1) of each wind turbine 310 may be configured to couple the respective wind turbine to the control network 370. Such coupling of the wind turbines 310 may facilitate the exchange of control information between the wind turbines 310 of a wind park, as will be discussed in greater detail below.

FIG. 4 depicts a block diagram of a network computer 150 of a wind turbine, according to an embodiment of the invention. The network computer 150 may include a Central Processing Unit (CPU) 411 connected via a bus 420 to a memory 412, storage 416, an input device 417, an output device 418, and a network interface device 419.

The input device 417 can be any device to give input to the network computer 150. In one embodiment, the input device 417 may be coupled with one or more sensors of a wind turbine, for example, the sensors 113, 123, and 133 of FIG. 1 and sensors 221 and 231 illustrated in FIG. 2. In some embodiments, the input device 417 may be configured to receive user input. According, the input device 417 may be a keyboard, keypad, light-pen, touch-screen, track-ball, or speech recognition unit, audio/video player, or the like.

The output device 418 can be any device to give output to a user, e.g., any conventional display screen. In some embodiments, the output device may be a device configured to set off an alarm, for example, by flashing emergency lights, setting off an audible alarm, sending text or electronic messages to predefined persons, etc. The network interface device 419 may be any entry/exit device configured to allow network communications between a plurality of network computers 150 via the network 370. For example, the network interface device 419 may be a network adapter or other network interface card (NIC).

Storage 416 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 412 and storage 416 could be part of one virtual address space spanning multiple primary and secondary storage devices.

The memory 412 is preferably a random access memory sufficiently large to hold the necessary programming and data structures of the invention. While memory 412 is shown as a single entity, it should be understood that memory 412 may in fact comprise a plurality of modules, and that memory 412 may exist at multiple levels, from high speed registers and caches to lower speed but larger DRAM chips.

Illustratively, the memory 412 contains an operating system 413. Illustrative operating systems, which may be used to advantage, include Linux (Linux is a trademark of Linus Torvalds in the US, other countries, or both) and Microsoft's Windows®. More generally, any operating system supporting the functions disclosed herein may be used.

Memory 412 is also shown containing a control program 414 which, when executed by CPU 411, provides support for exchanging control data between wind turbines. In one embodiment, exchanging control data between wind turbines in a wind park may allow the wind turbines of the wind park to regulate capture of energy. For example, control data that is captured or derived at one wind turbine may be transferred to one or more other turbines, which may preemptively adjust one or more operational parameters to capture more energy from the wind, prevent damage to the turbine, reduce loads, and the like.

The memory 412 may also include wind park data 415. Wind park data 415 may include information regarding the specific number and types of turbines within the wind park, their status (e.g., active, not active, fault), location, proximity, and the like.

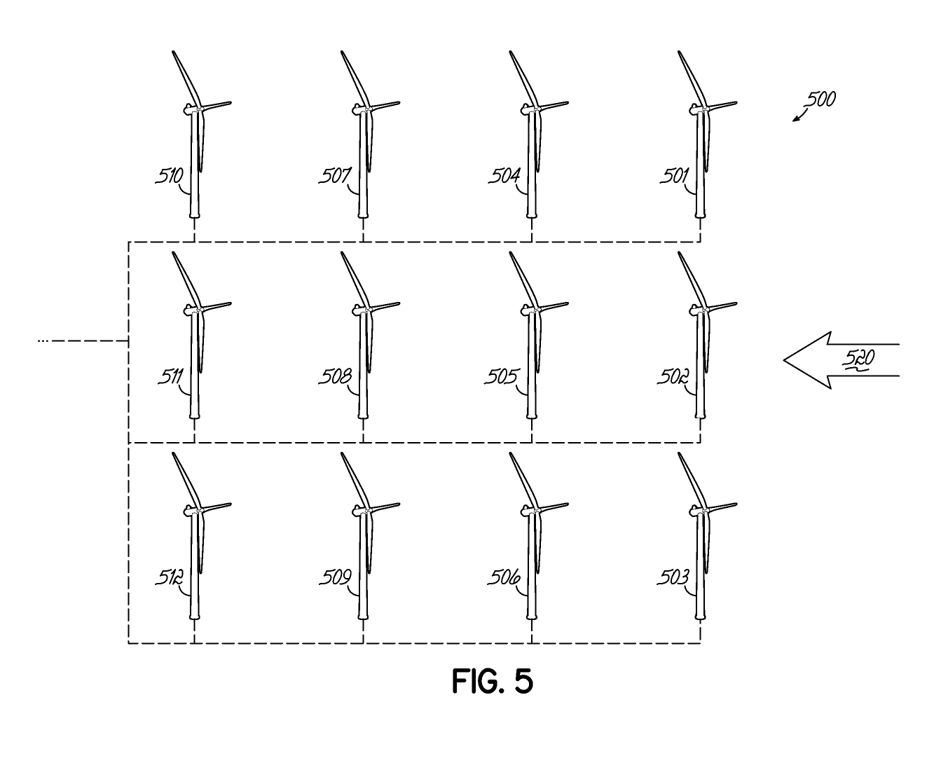

For example, a wind park 500 comprising a plurality of wind turbines 501-512 is illustrated in FIG. 5. The turbines 501-512 are connected to each other via a control network, for example, the control network 370 illustrated in FIG. 3. As further illustrated in FIG. 5, a wind gust 520 may approach the wind park 500. The wind gust may first be detected by, for example, wind sensors at the wind turbines 501-503. In one embodiment of the invention, the wind turbines 501-503 may transfer an indication of an approaching wind gust, e.g., wind speed and direction, to the remaining turbines 504-512 before the wind gust arrives at the turbines 504-512. An advanced indication of the approaching wind gust may allow the turbines 504-512 to adjust one or more operational parameters to avoid damage to the blades, more efficiently capture the energy from the wind gust, and the like. For example, the turbines 504-512 may adjust a pitch angle of respective blades based on the data regarding the approaching wind gust that is transferred from turbines 501-503. In one embodiment of the invention, the wind turbines 504-512 may also consider the wake effect caused by one or more turbines in the wind path while determining the pitch angle, thereby optimizing power production.

In one embodiment, the wind turbines 501-512 may be configured to exchange data regarding faults at the turbines with one another. For example, suppose that catastrophic faults cause turbines 510 and 507 to cease producing power. In one embodiment, the turbines 510 and 507 may notify the remaining turbines in the wind park regarding the cessation of power production. Accordingly, in some embodiment, the remaining turbines of the wind park may adjust one or more operational parameters to generate additional power to compensate for the loss in production from the turbines 510 and 507.

In one embodiment of the invention, the wind turbines 501-512 may be configured mutually activate or deactivate one or more turbines based on requirements of the grid. For example, during peak hours, all or a majority of wind turbines 501-512 may be active. However, during non-peak hours, one or more turbines 501-512 may be deactivated. The specific turbines to be deactivated may be determined by communication between the plurality of turbines 501-512. In some embodiments, each of the turbines 501-512 may be given an equal amount of deactivation time in a predefined period so as to minimize excessive use and consequently wear and tear of only a select few turbines of the wind park.

The examples above describing the exchange of data between wind turbines to facilitate the wind turbines to proactively adjust one or more operational parameters to, for example, increase energy production, reduce damage to the turbine, reduce loads, etc., are provided for illustrative purposes only. Embodiments of the invention are not limited to the described examples. More generally any exchange of data between one or more turbines to facilitate proactive reaction by the turbines to regulate power production and/or reduce damage to components falls within the purview of the invention.

In one embodiment of the invention, the wind turbines on a perimeter of the wind park may be equipped with Light Detection And Ranging (LIDAR) devices. LIDAR devices may be capable emitting optical signals and detecting scattered light from the emitted optical signals to determine one or more properties of oncoming wind, for example, wind speed, direction, and the like. Wind data collected from LIDAR devices on wind turbines along a perimeter of the wind park may be transferred to other wind turbine in the wind park, in one embodiment.

For example, the wind turbines 501-504, 506, 507, and 509-512 of Wind Park 500 may be equipped with LIDAR devices. Wind data collected from the wind turbines 501-504, 506, 507, and 509-512 may be transferred to the wind turbines 505 and 508. Control Programs at the wind turbines 505 and 508 may be configured to determine one or more properties of oncoming wind based on the wind data received from the wind turbines 501-504, 506, 507, and 509-512. Based on the determined properties of the wind, the wind turbines may proactively perform one or more operations such as yawing, pitching of blades, and the like to increase energy capture, reduce loads, and the like.

In one embodiment of the invention, the each of the wind turbines 501-512 may be configured to receive control data from a plurality of other wind turbines in the wind park. For example, a plurality of wind turbines may send wind data collected from respective sensors to the wind turbine 505 in FIG. 5. Turbine 505 may analyze and/or combine the wind data received from multiple turbines and optimize the wind data for use by the wind turbine 505. For example, the wind turbine 505 may average the wind data received from the multiple turbines.

In some embodiments, a given wind turbine may be configured to combine control data received from multiple turbines using a weighted data combination scheme, e.g., a weighted average. Accordingly, the given turbine may store predefined weight values for each wind turbine in the park within a respective memory device. In one embodiment, turbines that are located closest to the given turbine may have a greater weight than turbines that are further away.

In one embodiment of the invention, a subset of the wind turbines in the wind park may be a part of a predefined cluster of wind turbines. For example, the wind turbines 501-503 may form a first cluster and the wind turbines 504-506 may form a second cluster. In one embodiment, control data for a cluster of wind turbines may be aggregated and transferred to wind turbines of another cluster. For example, sensor or control data from wind turbines 501-503 may be collected and combined by wind turbine 502, which may represent a master turbine for the first cluster. The wind turbine 502 may transfer the combined control or sensor data to wind turbines 504-506 of the second cluster via the control network.

Any reasonable basis may be used to organize the wind turbines of a wind park into a cluster. For example, wind turbines along a north facing perimeter of the wind park may form a first cluster, wind turbines at a center of the wind park may form a second cluster, wind turbines having a specific type of sensor not included in other turbines may form a third cluster, and the like.

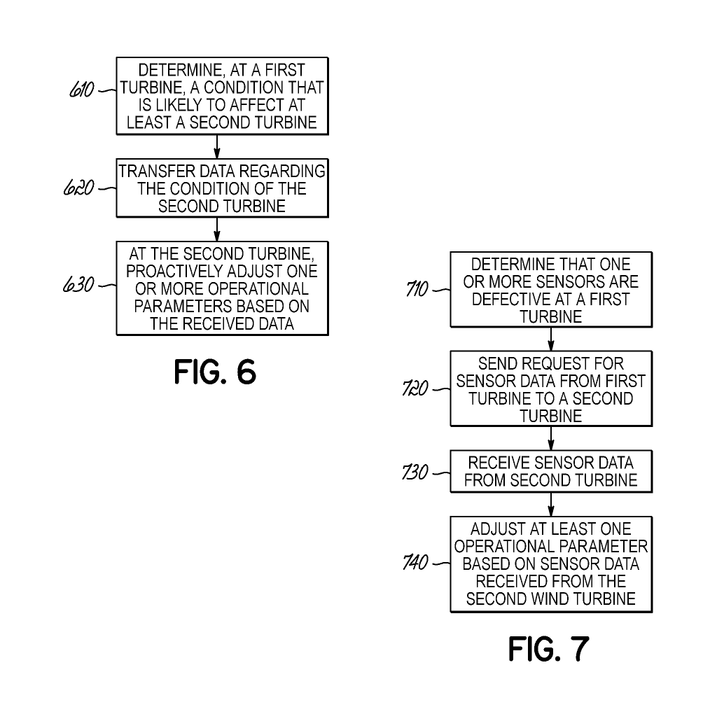

FIG. 6 is a flow diagram of exemplary operations performed by wind turbines of a wind park according to an embodiment of the invention. The operations begin in step 610 by determining, at a first turbine, a condition that is likely to affect at least a second turbine of the wind park. Exemplary conditions may include, for example, a wind gust, fault at a turbine, extreme loads, and the like. In step 620, data regarding the condition may be transferred to at least the second turbine of the wind park. For example, sensor data or data derived from sensor data may be transferred to the second wind turbine via a control network. In step 630, the second wind turbine may proactively adjust one or more operational parameters based on the received data.

The method steps described hereinabove may be performed by one or more network computers at the wind turbines, e.g., the network computer 150 illustrated in FIG. 1. For example, the control program 414 in the first turbine may monitor input data from sensors received, for example, via an input device 417. The control program 414 may detect whether a condition that is likely to affect other turbines in the wind park is occurring at the first wind turbine. In response, the control program 414 may transfer the data related to the condition to a networked computer in one or more other turbines, e.g., the second wind turbine. The control program 414 in a networked computer at the second wind turbine may receive the data related to the condition and perform operations to adjust one or more operational parameters of the second wind turbine.

In one embodiment of the invention, the turbines of a wind park may be configured to communicate with each other via a centralized computer. For example, in one embodiment a network computer at a designated wind turbine, or a separate computer located at the wind park may act as a master computer for receiving and transferring control data between wind turbines. In such embodiments, each wind turbine may be configured to transfer control data to the master computer and designate a desired location for the transfer.

In some embodiment, the control network may be used to facilitate operation of wind turbines having one or more defective sensors. For example, suppose a wind sensor at a first turbine develops a fault and is no longer able to capture wind data. In some embodiments, the first turbine may be configured to request wind data captured by wind sensors at one or more adjacent turbines via the control network. The first turbine may be configured to adjust operational parameters based upon wind data received from other turbines via the control network.

FIG. 7 is a flow diagram illustrating exemplary operations that may be performed at a wind park according to an embodiment of the invention. The operations may begin in step 710 by determining that one or more sensors at a first turbine are defective. In response to determining that one or more sensors are defective, the first turbine may send a request for sensor data to at least one second turbine in the wind park, in step 720. In step 730, the first turbine may receive sensor data from at least the second turbine in the wind park. In step 740, the first turbine may adjust at least one operational parameter in response to receiving the sensor data from the second turbine.

In some embodiments, the first turbine may send the request for sensor data to multiple adjacent turbines. Accordingly, it is possibly that the first turbine may receive sensor data from a plurality of turbines in the wind park. In such embodiments, the control software at the first turbine may be configured to combine the sensor data received from multiple turbines to determine control data for the first turbine. For example, in one embodiment, the control software may average (with or without weighting) the sensor data received from the multiple turbines of the wind park.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept

1. A method for operating a wind park, comprising:
at a first wind turbine in the wind park, determining a condition that will affect at least a second wind turbine of the wind park;
transferring data regarding the condition to the second wind turbine via a control network coupling the first wind turbine to at least the second wind turbine; and
at the second wind turbine, adjusting at least one operational parameter of the second wind turbine in response to receiving the data regarding the condition from the first wind turbine.

2. The method of claim 1, wherein determining the condition comprises detecting a wind gust, wherein transferring the data regarding the condition comprises transferring at least a wind speed and a wind direction of the wind gust to at least the second wind turbine.

3. The method of claim 2, wherein adjusting the at least one operational parameter of the second wind turbine comprises adjusting a pitch angle of blades of the second wind turbine.

4. The method of claim 1, wherein the first wind turbine is a part of a first predefined cluster of wind turbines in the wind park, and the second wind turbine is a part of a second cluster of wind turbines in the wind park.

5. A method for operating a wind park, comprising:
determining that a first sensor at a first wind turbine is defective;
in response to determining that the first sensor is defective, transferring a request for sensor data from the first wind turbine to at least a second wind turbine of the wind park, wherein the request is transferred via a control network coupling the first wind turbine and the second wind turbine; and
in response to receiving the request from the first wind turbine, transferring data captured by a second sensor at the second wind turbine to the first wind turbine via the control network.

6. The method of claim 5, further comprising, at the first wind turbine, adjusting at least one operational parameter based on the data captured by the second sensor received from the second wind turbine.

7-10. (canceled)

11. A wind park comprising a plurality of wind turbines, each wind turbine comprising a networked computer, wherein at least a first networked computer in a first wind turbine is coupled with at least one second networked computer in a second wind turbine via a control network, and wherein the first networked computer and the second networked computer each comprise:
a memory comprising a control program; and
a processor which, when executing the control program is configured to perform operations for exchanging control data between the first networked computer and the second networked computer.

12. The wind park of claim 11, wherein at the first networked computer of the first wind turbine is configured to determine a condition that will affect the second wind turbine and transfer data regarding the condition to the second wind turbine via the control network, and wherein the second networked computer is configured to adjust at least one operational parameter of the second wind turbine in response to receiving the data regarding the condition.

13. The wind park of claim 12, wherein the adjustment of the at least one operational parameter is performed to one of:
prevent damage to components of the second wind turbine;
improve efficiency of energy capture at the second wind turbine; or
reduce loads at the second wind turbine.

14. The wind park of claim 12, wherein determining the condition comprises detecting a wind gust, wherein transferring data regarding the condition comprises transferring at least a wind speed and a wind direction of the wind gust to at least the second wind turbine, and wherein adjusting the at least one operational parameter of the second wind turbine comprises adjusting a pitch angle of blades of the second wind turbine.

15. The wind park of claim 11, wherein the first networked computer is configured to determine that a first sensor at the first wind turbine is defective, and in response to determining that the first sensor is defective, transfer a request for sensor data from the first wind turbine to at least the second wind turbine, wherein the request is transferred via the control network; and
wherein the second networked computer is configured to transfer data captured by a second sensor at the second wind turbine to the first wind turbine via the control network in response to receiving the request from the first wind turbine.

16. The wind park of claim 15, further comprising, at the first wind turbine, adjusting at least one operational parameter based on the data captured by the second sensor received from the second wind turbine.

17. The wind park of claim 11, wherein the control network is a local area network (LAN).

18. The wind park of claim 11, wherein each networked computer is configured to broadcast the control data to all of the wind turbines in the wind park.

19. The wind park of claim 11, wherein the memory further comprises wind park data defining a location of each of the wind turbines in the wind park.

20. The wind park of claim 11, wherein at least a third wind turbine of the plurality of wind turbines located along a perimeter of the wind park comprises a Light Detection And Ranging (LIDAR) device, and wherein the third wind turbine is configured to transfer wind data regarding oncoming wind collected from the LIDAR device to at least a fourth wind turbine that is not located along the perimeter of the wind park.

21. The wind park of claim 20, wherein the fourth wind turbine is configured to determine at least one property of the oncoming wind based on at least the wind data received from the third wind turbine.
